(19) United States
(12) Patent Application Publication
(10) Pub. No.: US 2021/0242597 A1
(43) Pub. Date: Aug. 5, 2021

(54) COMMUNICATIONS DEVICE

(71) Applicant: SHARP KABUSHIKI KAISHA, Sakai City (JP)

(72) Inventors: NAOKI SOTOMA, Sakai City (JP); HIROKI KASHIWAGI, Sakai City (JP)

(21) Appl. No.: 17/150,358

(22) Filed: Jan. 15, 2021

(30) Foreign Application Priority Data
Jan. 31, 2020 (JP) 2020-014758

(51) Int. Cl. H01Q 9/04; H01Q 1/52; H01Q 15/24

(52) U.S. Cl. CPC H01Q 9/0478; H01Q 15/24; H01Q 1/52

(57) ABSTRACT

A communications device includes: an antenna radiating a first radio wave having a first polarization direction and a second radio wave having a second polarization direction, the first and second polarization directions being different; a casing provided with an opening through which the first radio wave and the second radio wave pass; and a cover provided to the opening and including a plurality of bars made of metal. The antenna is disposed so that neither the first polarization direction of the first radio wave nor the second polarization direction of the second wave orthogonally intersects with an extending direction of the bars.

### CROSS-REFERENCE TO RELATED APPLICATION

The present application claims priority from Japanese Application JP2020-014758, the content of which is hereby incorporated by reference into this application

### BACKGROUND OF THE INVENTION

### 1. Field of the Invention

The present invention relates to a communications device.

### 2. Description of the Related Art

Japanese Patent No. 4240521 discloses a planar antenna including a polarized grid (a metal cover). The polarized grid includes a plurality of strip lines (bars) arranged, orthogonally to the direction of a polarized wave, above a plane in parallel with an opening face of the planar antenna. The planar antenna radiates a linearly polarized wave.

The planar antenna is connected to the polarized grid through a metal wall provided to an end of the planar antenna. Thanks to this structure, the planar antenna can reduce cross polarization over a wide angle.

### SUMMARY OF THE INVENTION

A problem of the planar antenna. disclosed in the above Japanese Patent No. 4240521 (hereinafter referred to as a typical planar antenna) is that, if the typical planar antenna is a dual polarized antenna in which one antenna radiates radio waves whose polarized waves travel in different directions (i.e., whose polarization directions are different), the typical planar antenna cannot curb a decrease in gain of co-polarization.

An aspect of the present disclosure provides a communications device including an antenna radiating radio waves whose polarization directions are different. The communications device can curb a decrease in gain of the antenna.

A communications device according to an aspect of the present disclosure includes: an antenna radiating a first radio wave having a first polarization direction and a second radio wave having a second polarization direction, the first and second polarization directions being different; a casing provided with an opening through which the first radio wave and the second radio wave pass; and a cover provided to the opening and including a plurality of bars made of metal.

The antenna is disposed so that neither the first polarization direction of the first radio wave nor the second polarization direction of the second wave orthogonally intersects with an extending direction of the bars.

### BRIEF DESCRIPTION OF THE DRAWINGS

FIG. 1 is a block diagram schematically illustrating a configuration of a transmitter included in a communications device according to a first embodiment;

FIG. 2 is a block diagram schematically illustrating a configuration of a receiver included in the communications device according to the first embodiment;

FIG. 3 is a plan view schematically illustrating a positional relationship between an antenna and a cover included in the communications device according to the first embodiment;

FIG. 4 is a cross-section taken along line S-S′ in FIG. 3;

FIG. 5 is a plan view illustrating an example of a positional relationship between the antenna and the cover included in the communications device according to a first modification of the first embodiment;

FIG. 6 is a plan view illustrating an example of a positional relationship between the antenna and the cover included in the communications device according to a second modification of the first embodiment;

FIG. 7 is a plan view illustrating an example of an other positional relationship between the antenna and the cover included in the communications device according to the second modification of the first embodiment; and

FIG. 8 is a plan view schematically illustrating a positional relationship between an antenna and a cover included in a communications device according to a second embodiment.

### DETAILED DESCRIPTION OF THE INVENTION

Described below are embodiments and modifications of the present disclosure with reference to the drawings. It is to be noted that like reference numerals designate identical or corresponding components throughout the drawings. Moreover, the embodiments and modifications below are mere examples of the present disclosure, and the present disclosure shall not be limited to such embodiments and modifications. The present disclosure may be modified in various manners other than the embodiments and modifications in accordance with, for example, designs, unless departing from the technical scope of the present disclosure.

### First Embodiment

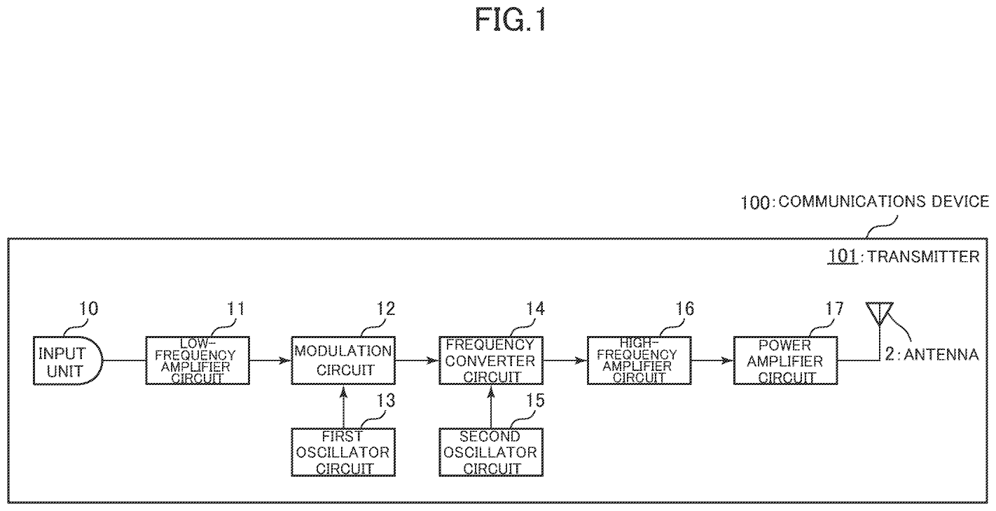

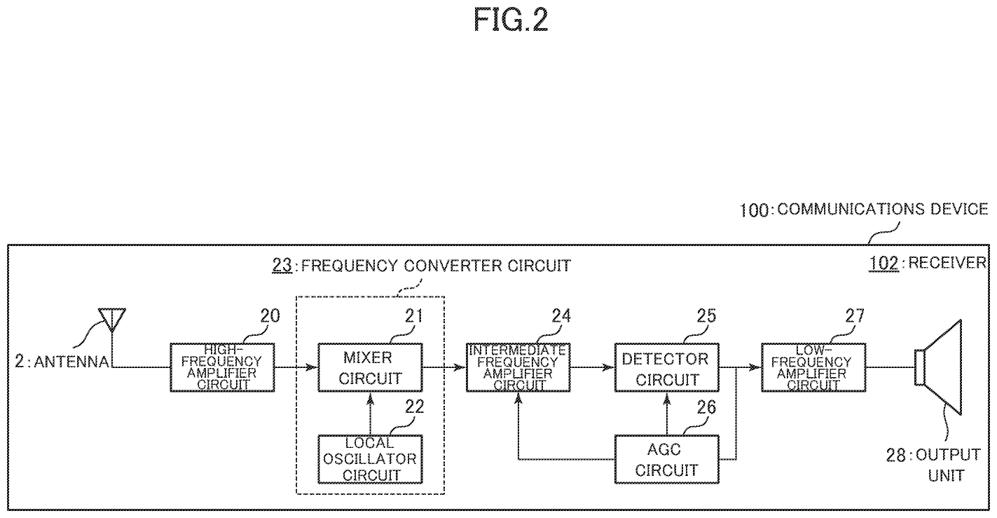

Described below is a communications device 100 according to a first embodiment, with reference to FIGS. 1 and 2. FIG. 1 is a block diagram schematically illustrating a configuration of a transmitter 101 included in the communications device 100 according to the first embodiment. FIG. 2 is a block diagram schematically illustrating a configuration of a receiver 102 included in the communications device 100 according to the first embodiment.

The communications device 100 of the first embodiment is an appliance performing wireless communication with, for example, an other appliance. As illustrated in FIGS. 1 and 2, the communications device 100 includes: the transmitter 101 transmitting a signal on a radio wave from an antenna 2; and the receiver 102 receiving a signal through the antenna 2.

As illustrated in FIG. 1, the transmitter 101 includes, for example: an input unit 10; a low-frequency amplifier circuit 11; a modulation circuit 12; a first oscillator circuit 13; a frequency converter circuit 14; a second oscillator circuit 15; a high-frequency amplifier circuit 16; and a power amplifier circuit 17. In the transmitter 101, the low-frequency amplifier circuit 11 amplifies a signal, input from the input unit 10 (e.g., a microphone), to a required level. After that, the modulation circuit 12 modulates the signal amplified by the low-frequency amplifier circuit 11, using a signal transmitted from the first oscillator circuit 13. The frequency converter circuit 14 converts the modulated signal to have an intended frequency, using a signal transmitted from the second oscillator circuit 15. The high-frequency amplifier circuit 16 amplifies the converted signal to a required level. The power amplifier circuit 17 amplifies the power of the amplified signal to a required power, and transmits the signal through the antenna 2.

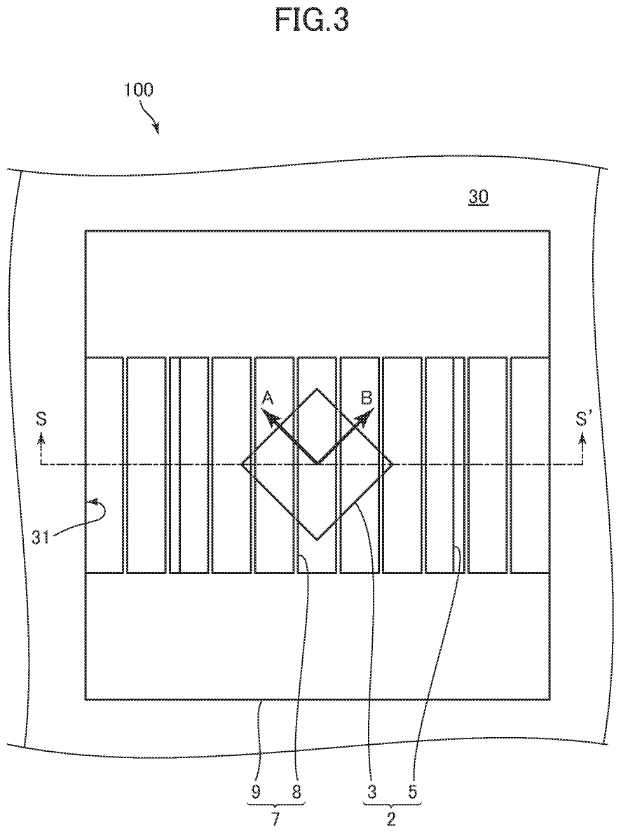

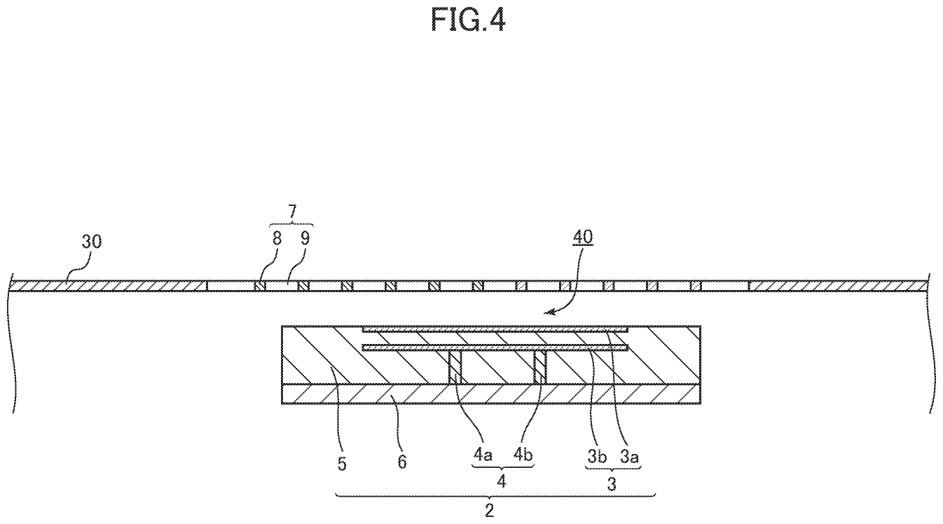

Furthermore, as illustrated in FIG. 2, the receiver 102 includes: a high-frequency amplifier circuit 20 tuning and amplifying a received radio wave; a frequency converter circuit 23 including a mixer circuit 21 and a local oscillator circuit 22, and converting a frequency of the amplified radio wave into an intermediate frequency; an intermediate frequency amplifier circuit 24 amplifying the intermediate frequency to a required level; a detector circuit 25 detecting a signal; an automatic gain control (AGC) circuit 26 automatically controlling a gain of the signal in accordance with the input (the strength of the radio wave); a low-frequency amplifier circuit 27 amplifying the detected signal; and an output unit 28 (e.g., a speaker). Described next is the antenna 2 included in the communications device 100, with reference to FIGS. 3 and 4. FIG. 3 is a plan view schematically illustrating a positional relationship between the antenna 2 and a cover 7 included in the communications device 100 according to the first embodiment. FIG. 4 is a cross-section taken along line S-S′ in FIG. 3. FIG. 3 illustrates a positional relationship between, and major parts of, the antenna 2 and the cover 7 observed in planar view from a radiating face 40 of the antenna 2. Moreover, FIG. 4 illustrates an example of a cross-sectional structure of the antenna 2 and the cover 7 illustrated in FIG. 3. In this DESCRIPTION, a face, of the antenna 2, radiating a radio wave is referred to as the radiating face 40.

The antenna 2 is a dual polarized antenna including a radiating element 3. As illustrated in FIG. 3, the radiating element 3 radiates a first radio wave and a second radio wave polarization directions of which are different, The antenna 2 according to the first embodiment includes one radiating element 3. Alternatively, the number of radiating elements 3 shall not be limited to one. Any given number of radiating elements 3 may be provided. Note that the statement “polarization directions of which are different” means that the first radio wave and the second radio wave travel in different polarization directions in a single plane.

As illustrated in FIG. 4, the antenna 2 includes: a dielectric substrate 5; the radiating element 3 including an upper conductor 3a and a lower conductor 3b wired in the dielectric substrate 5; and a ground conductor plate 6. As illustrated in FIGS. 3 and 4, in the antenna 2, the radiating element 3 shaped into a square in planar view is disposed in an upper face of the dielectric substrate 5, and the ground conductor plate 6 is disposed across the dielectric substrate 5 from the radiating element 3. Furthermore, the antenna 2 includes: a first power supplier 4a for radiating the first radio wave in a first polarization direction A; and a second power supplier 4b for radiating the second radio wave in a second polarization direction B. The first power supplier 4a and the second power supplier 4b supply power from a back face of the antenna 2 to the radiation element 3 (back-face coaxial feeding). Note that the back face of the antenna 2 is provided with the ground conductor plate 6, and positioned across from the radiating face 40 radiating a radio wave. In the communications device 100 according to this embodiment, the first polarization direction A and the second polarization direction B of the antenna 2 orthogonally cross each other on the radiating face 40 as illustrated in FIG. 3. However, the first polarization direction A and the second polarization direction B do not necessarily have to cross orthogonally on the radiating face 40. The first polarization direction A and the second polarization direction B may be determined in any given direction, depending on polarization directions to be required for the antenna 2.

In the antenna 2, each of the first power supplier 4a and the second power supplier 4b can be, for example, a coaxial line. The coaxial line has an inner conductor connected to the radiation element 3, and an outer conductor connected to the ground conductor plate 6. Each of the first power supplier 4a and the second power supplier 4b has a feeding point appropriately positioned on the radiation element 3 to obtain impedance matching. Note that the dielectric substrate 5 and the ground conductor plate 6 have a through hole therein so that the inner conductors to be connected to the first power supplier 4a and the second power supplier 4b can run through the dielectric substrate 5 and the ground conductor plate 6.

Note that a technique to supply power to the radiation element 3 shall not be limited to the above back-face coaxial feeding. The technique may also be so-called coplanar feeding that involves disposing a microstrip line on the same plane as the radiation element 3, and supplying the radiation element 3 with power. Alternatively, instead of such a direct-coupling feeding technique, the power supply technique may also involve electromagnetically coupling the radiation element 3 to a microstrip line, and exciting the radiation element 3 to supply power to the radiation element 3 (i.e., the electromagnetic coupling feeding technique).

### Positional Relationship between Antenna and Cover

The communications device 100 includes a casing 30 provided with an opening 31, toward the radiating face 40 of the antenna 2, through which a radiated radio wave passes. The opening 31 is provided with a cover 7 in which a plurality of bars 8 made of metal are arranged to maintain, for example, physical strength of the casing 30.

Here, the gain of the antenna 2 varies depending on a relative positional relationship between the bars 8 of the cover 7 and the antenna 2. For example, if a relative positional relationship between the antenna 2 and the cover 7 is similar to that between a typical planar antenna and the cover 7, one of the polarization directions is in parallel with an extending direction of the bars 8. However, the other polarization direction and the extending direction of the bars 8 orthogonally intersect, with each other.

Here, a radio wave, whose polarization direction is in parallel with the bars 8 of the cover 7, is not blocked when radiating. However, an other radio wave, whose polarization direction orthogonally intersects with the bars 8 of the cover 7, is blocked by the bars 8 when radiating. In particular, when the polarization direction and the extending direction of the metal bars 8 orthogonally intersect with each other, the radiation of the radio wave is blocked the most so that the gain of the antenna 2 decreases the most.

That is why, in the communications device 100, the relative positional relationship between the antenna 2 and the cover 7 is determined so that neither the first polarization direction A nor the second polarized direction B orthogonally intersects with the extending direction of the bars 8 of the cover 7.

Described below is a positional relationship between the cover 7 and the antenna 2 in the communications device 100 according to the first embodiment, in particular a positional relationship between the bars 8 of the cover 7 and the radiation element 3, with reference to above FIG. 3.

As illustrated in FIG. 3, the communications device 100 includes: the antenna 2 including the radiating element 3 radiating radio waves polarization directions of which are different; the casing 30 provided with the opening 31, toward the radiating face 40 of the antenna 2, through which the radiated radio waves pass; and the cover 7 provided to the opening 31 and including the bars 8 made of metal. That is, the cover 7 is shaped into a so-called ladder, such that the bars 8 extending in the same direction are periodically arranged at regular intervals. The antenna 2 is disposed so that neither the first polarization direction A (i.e., the polarization direction of the first radio wave) nor the second polarization direction B (i.e., the polarization direction of the second radio wave) orthogonally intersects with the extending direction of the bars 8 provided to the cover 7. Note that, when the first polarization direction A and the second polarization direction B orthogonally intersect with the extending direction of the bars 8 of the cover 7, the first polarization direction A and the second polarization direction B may intersect with the extending direction of the bars 8 at an angle of not only 90° but also around 90°. An example of a range of the angle to be interpreted as the orthogonal intersection may be a range, of a gain of the antenna 2, in which the gain is substantially the same as that observed when the first polarization direction A and the second polarization direction B orthogonally intersects with the extending direction of the bars 8.

As described above, in the communications device 100 according to the first embodiment, neither of main polarization directions (i.e., the first polarization direction A and the second polarization direction B) of the antenna 2 orthogonally intersects with the extending direction of the bars 8. Hence, even though the bars 8 decrease the gain, the decrease here can be curbed less than that in the case where the polarization directions orthogonally intersect with the extending direction of the bars 8. Thus, the decrease in the gain can be curbed in both the first polarization direction A and the second polarization direction B. As a result, the communications device 100 according to the first embodiment achieves an advantageous effect of curbing a decrease in the gain of the antenna 2 included in the communications device 100 and radiating radio waves whose polarization directions are different.

Note that the relative positional relationship between the antenna 2 and the cover 7 may be determined as described below. That is, the antenna 2 may be disposed so that neither the first polarization direction A nor the second polarization direction B orthogonally intersects with, or runs in parallel with, the extending direction of the bars 8. In FIG. 3, when the first polarization direction A and the second polarization direction B orthogonally intersect with each other on the radiating face 40, the antenna 2 is disposed so that an angle (i.e., an acute angle) formed between the extending direction of the bars 8 and the first polarization direction A and an angle (i.e., an acute angle) formed between the extending direction of the bars 8 and the second polarization direction B are both 45°. Such an arrangement makes it possible to effectively curb the decrease in the gain of the antenna 2.

Moreover, the cover 7 includes a pair of connections 9 made of metal. The connections 9 are provided to opposing ends of the bars 8 to connect the bars 8 together. Hence, the cover 7 allows the bars 8 to be kept arranged periodically at regular intervals. Furthermore, the connections 9 can appropriately connect the cover 7 to the casing 30. Note that, in the cover 7, a clearance between the connections 9 is wider than or equal to half a wavelength of the radio waves (the first radio wave and the second radio wave) to be radiated from the antenna 2. For example, when the antenna 2 according to the first embodiment radiates a radio wave having a wavelength λ of approximately 10.7 mm, the clearance between the connections 9 may be wider than or equal to half the wavelength of the radio wave (e.g., approximately 5.4 mm). As can be seen, the clearance between the connections 9 is set wider than or equal to half the wavelength of a radio wave to be radiated. Such a feature makes it possible to curb a decrease in the gain of the antenna 2. Note that, as illustrated in FIG. 3, the connections 9 are formed separately from the casing 30. Alternatively, the connections 9 may be a part of the casing 30. In addition, the opening 31 provided with the cover 7 may be blocked from the outside of the casing 30, using a material such as resin conducting a radio wave. As can be seen, the opening 31 of the casing 30 is blocked from the outside, using, for example, resin. The feature can prevent such a substance as a foreign object to enter an interior of the communications device 100 through the opening 31.

As illustrated in FIG. 3, the first polarization direction A of the antenna 2 intersects with a pair of facing sides of the radiating element 3, and the second polarization direction B of the antenna 2 intersects with an other pair of facing sides of the radiating element 3. When the first polarization direction A and the second polarization direction B are in such a relationship, the diagonals of the radiating element 3 do not run in the main polarization directions. Hence, even if a member preventing radiation of a radio wave is found in an extension of a diagonal, the member does not significantly affect a decrease in the gain of the antenna 2. Thus, when the antenna 2 is observed in planar view from the radiating face 40, the cover 7 may include a reinforcement formed in an extension of a diagonal of the radiating element 3. The reinforcement included in the cover 7 may specifically be described in examples in first and second modifications.

### First Modification

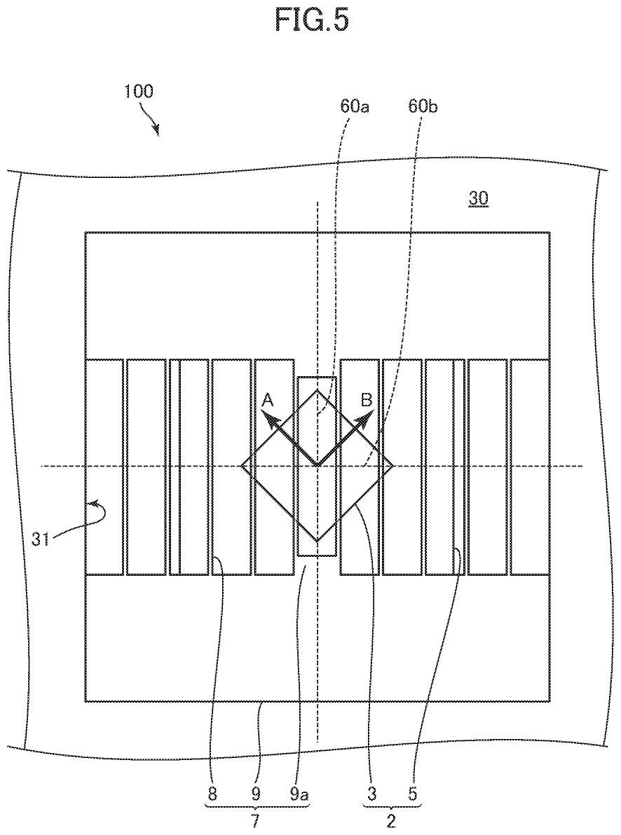

Described below is the communications device 100 according to the first modification, with reference to FIG. 5. FIG. 5 is a plan view illustrating an example of a positional relationship between the antenna 2 and the cover 7 included in the communications device 100 according to the first modification of the first embodiment.

Compared with the communications device 100 according to the above first embodiment, the communications device 100 according to the first modification is the same in the configuration of the antenna 2, but is different in the configuration of the cover 7. More specifically, when the antenna 2 is observed in planar view from the radiating face 40, the radiating element 3 is shaped into a square in planar view, The radiating element 3 has a first diagonal 60a running in the extending direction of the bars 8 and a second diagonal 60b intersecting with the extending direction of the bars 8. The first polarization direction A runs in a direction intersecting with a pair of facing sides of the radiating element 3, and the second polarization direction B runs in a direction intersecting with an other pair of facing sides of the radiating element 3. In the antenna 2 according to the first modification, when observed in planar view from the radiating face 40 as illustrated in FIG. 5, the second diagonal 60b orthogonally intersects with the extending direction of the bars 8.

Meanwhile, when the antenna 2 is observed in planar view from the radiating face 40, the cover 7 includes a pair of first reinforcements 9a made of metal. In an extension of the first diagonal 60a of the radiating element 3, each of the first reinforcements 9a extends from a corresponding one of the connections 9 so that the first reinforcements 9a face each other. In FIG. 5, when the antenna 2 is observed in planar view from the radiating face 40, the first reinforcements 9a are positioned not to overlap the radiating element 3. Preferably, the first reinforcements 9a do not overlap the radiating element 3; however, the first reinforcements 9a may partially overlap a corner, of the radiating element 3, in the first diagonal 60a.

As can be seen, the first reinforcements 9a included in the cover 7 can enhance the strength of the cover 7, and consequently enhance the strength of the whole casing 30.

Moreover, in the antenna 2, each of the first polarization direction A and the second polarization direction B is set to orthogonally intersect with a pair of facing sides as illustrated in FIG. 5. Hence, the extension of the first diagonal 60a of the radiating element 3 does not run in a main polarization direction. Such a feature does not significantly block radiation of a first polarized wave and a second polarized wave. Hence, even if the first reinforcements 9a made of metal are provided in the extension of the first diagonal 60a, the gain of the antenna 2 does not decrease significantly.

### Second Modification

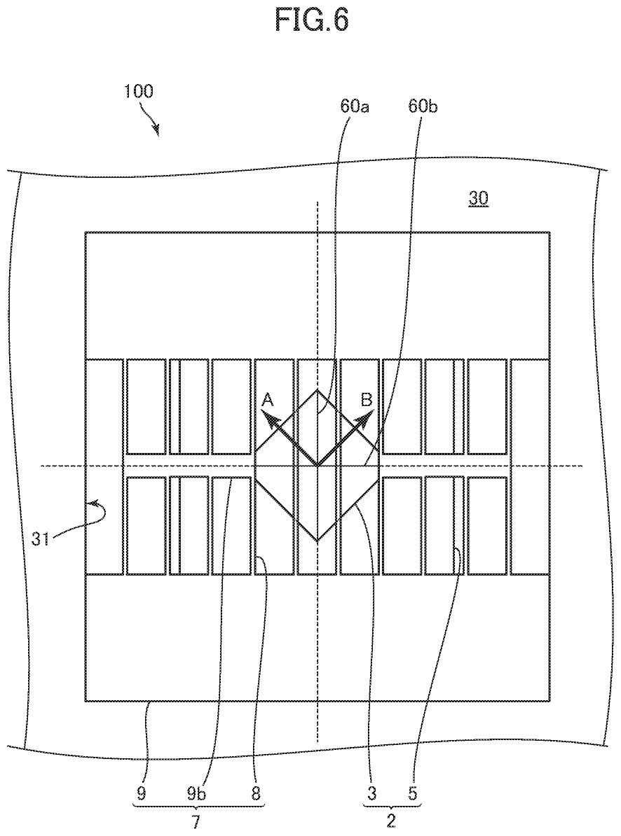

Moreover, described below is the communications device 100 according to the second modification, with reference to FIG. 6. FIG. 6 is a plan view illustrating an example of a positional relationship between the antenna 2 and the cover 7 included in the communications device 100 according to the second modification of the first embodiment.

Compared with the communications device 100 according to the above first modification, the communications device 100 according to the second modification is the same in the configuration of the antenna 2, but is different in the configuration of the cover 7.

That is, when observed in planar view from the radiating face 40 of the antenna 2, the cover 7 includes a pair of second reinforcements 9b made of metal. In an extension of the second diagonal 60b, the second reinforcements 9b are laid across the bars 8, As can be seen, the second reinforcements 9b included in the cover 7 can enhance the strength of the cover 7, and consequently enhance the strength of the whole casing 30. Preferably, just like the first reinforcements 9a, the second reinforcements 9b do not overlap the radiating element 3; however, the second reinforcements 9b may partially overlap a corner, of the radiating element 3, in the second diagonal 60b.

Moreover, in the antenna 2, each of the first polarization direction A and the second polarization direction B is set to orthogonally intersect with a pair of facing sides as illustrated in FIG. 6. Hence, the extension of the second diagonal 60b of the radiating element 3 does not run in a main polarization direction. Such a feature does not significantly block radiation of a first polarized wave and a second polarized wave. Hence, even if the second reinforcements 9b made of metal are provided in the extension of the second diagonal 60b, the gain of the antenna 2 does not decrease significantly.

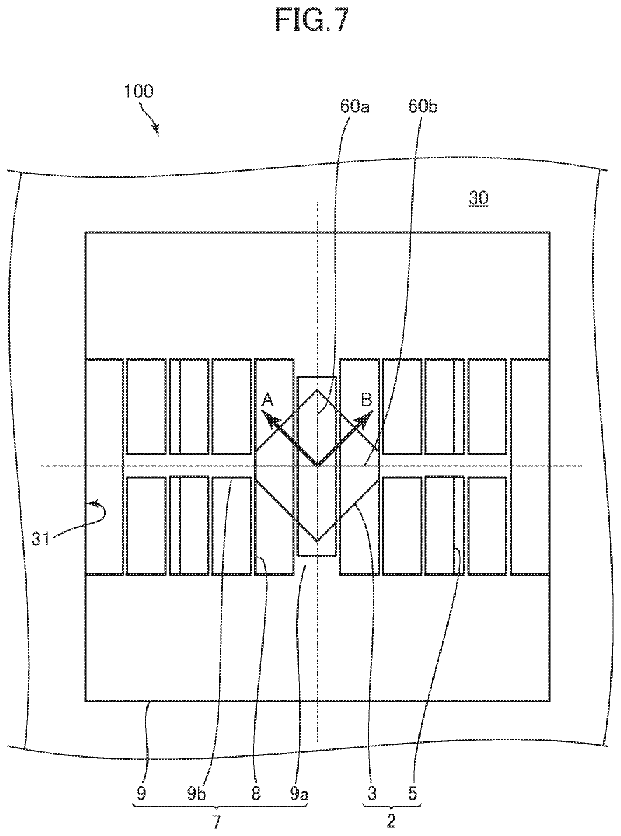

Note that, in the communications device 100 according to the second modification, the cover 7 may further include the above first reinforcements 9a in addition to the second reinforcements 9b as illustrated in FIG. 7. FIG. 7 is a plan view illustrating an example of an other positional relationship between the antenna 2 and the cover 7 included in the communications device 100 according to the second modification of the first embodiment. The strength of the cover 7 can further be enhanced when the cover 7 includes a pair of the first reinforcements 9a and a pair of the second reinforcements 9b as illustrated in FIG. 7, than when the cover 7 includes either the first reinforcements 9a or the second reinforcements 9b alone. Consequently, such a feature can further enhance the strength of the whole casing 30.

Note that, in the communications device 100 according to the first embodiment and the first and second modifications of the first embodiment, the cover 7 is shaped into, but not limited to, a ladder including the bars 8. For example, the cover 7 may be shaped into a matrix in which the bars 8 intersect.

### Second Embodiment

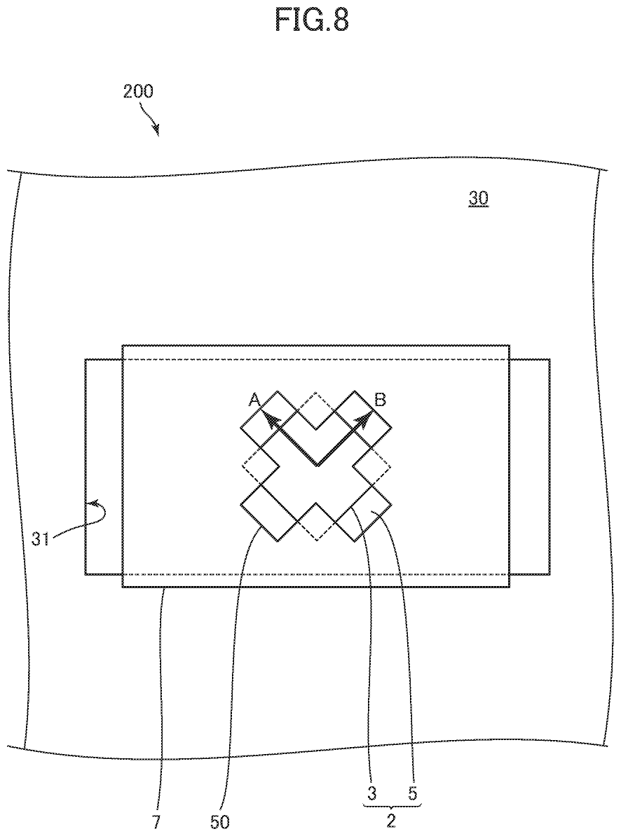

Described below is a communications device 200 according to a second embodiment, with reference to FIG. 8. FIG. 8 is a plan view schematically illustrating a positional relationship between the antenna 2 and the cover 7 included in the communications device 200 according to the second embodiment.

As illustrated in FIG. 8, the communications device 200 according to the second embodiment is the same in the configuration of the antenna 2 as the communications device 100 according to the first embodiment, but is different in the configuration of the cover 7. That is, the cover 7 included in the communications device 100 according to the first embodiment is shaped into a so-called ladder, such that the bars 8 each extending in the same direction are periodically arranged at regular intervals. In contrast, the communications device 200 according to the second embodiment is different in that the cover 7 is shaped into a plate including a space 50 in a predetermined position. Hence, the description of the antenna 2 is omitted, and only the cover 7 is described.

The cover 7 is a metal plate provided to the opening 31 of the casing 30, and capable of partially blocking the opening 31. When the antenna 2 is observed in planar view from the radiating face 40, the cover 7 includes the space 50 in a region corresponding to the radiating element 3. This space 50 is shaped into an X-shape to correspond to each of: a region extending, in the first polarization direction A, forward and backward from the radiating element 3 over a predetermined range; and a region extending, in the second direction B, forward and backward from the radiating element 3 over a predetermined range. The cover 7 can pass a radio wave radiated through this space 50. Note that, in the space 50, each of the ranges of the space 50 extending forward and backward from the radiating element 3 is set so that the range is wider than or equal to half a wavelength of the radio waves (the first radio wave and the second radio wave) to be radiated from the antenna 2. As can be seen, each range of the space 50 extending forward and backward from the radiating element 3 is set wider than or equal to half the wavelength of the radio wave to be radiated. Such a feature makes it possible to curb a decrease in the gain of the antenna 2.

The cover 7 made of a metal plate can to enhance the strength around a region, of the casing 30, provided with the opening 31. Moreover, the space 50 formed on the cover 7 can curb a decrease in the gain of the antenna 2.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A communications device, comprising:
an antenna configured to radiate a first radio wave having a first polarization direction and a second radio wave having a second polarization direction, the first and second polarization directions being different;
a casing provided with an opening through which the first radio wave and the second radio wave pass; and
a cover provided to the opening and including a plurality of bars made of metal,
the antenna being disposed so that neither the first polarization direction of the first radio wave nor the second polarization direction of the second wave orthogonally intersects with an extending direction of the bars.

2. The communications device according to claim 1, wherein
the antenna is disposed so that neither the first polarization direction nor the second polarization direction runs in parallel with the extending direction of the bars.

3. The communications device according to claim 1, wherein
the antenna is disposed so that angles formed between the extending direction of the bars and each of the first polarization direction and the second polarization direction are both 45°.

4. The communications device according to claim 1, wherein
the cover includes a pair of connections provided to opposing ends of the bars to connect the bars together.

5. The communications device according to claim 4, wherein
in the cover, a clearance between the connections is wider than or equal to half a wavelength of the first radio wave and the second radio wave to be radiated from the antenna.

6. The communications device according to claim 4, wherein
the antenna includes a radiating element shaped into a square in planar view,
the first polarization direction intersects with a pair of facing sides of the radiating element, and the second polarization direction intersects with an other pair of facing sides of the radiating element, and
the cover includes a reinforcement formed in an extension of a diagonal of the radiating element.

7. The communications device according to claim 6, wherein
the diagonal of the radiating element includes a first diagonal running in the extending direction of the bars, and
the reinforcement includes a pair of first reinforcements in an extension of the first diagonal of the radiating element, each of the first reinforcements extending from a corresponding one of the connections so that first reinforcements face each other.

8. The communications device according to claim 6, wherein
the reinforcement includes a pair of second reinforcements in an extension of a second diagonal included in the diagonal of the radiating element, the second reinforcements being laid across the bars.

9. A communications device, comprising:
an antenna configured to radiate a first radio wave having a first polarization direction and a second radio wave having a second polarization direction, the first and second polarization directions being different;
a casing provided with an opening through which the first radio wave and the second radio wave pass; and
a cover provided to the opening and including a space shaped into an X-shape, the space being formed in a region corresponding to (i) the radiating element, and (ii) each of: a region extending, in the first polarization direction, forward and backward from the radiating element over a predetermined range; and a region extending, in the second polarization direction, forward and backward from the radiating element over a predetermined range.
